(19) United States
(12) Patent Application Publication
(10) Pub. No.: US 2009/0065567 A1
(43) Pub. Date: Mar. 12, 2009

(54) APPARATUS AND METHOD FOR PROVIDING CONTENTS BY USING MACHINE-READABLE CODE

(76) Inventors: Jae-Jun Lee, Seoul (KR); Sang Hak Lee, Seoul (KR); Junghwan Park, Seoul (KR); Minjong Chung, Seoul (KR)

Correspondence Address: CHRISTIE, PARKER & HALE, LLP, PO BOX 7068, PASADENA, CA, 91109-7068, US

(21) Appl. No.: 11/946,826

(22) Filed: Nov. 28, 2007

(30) Foreign Application Priority Data
Sep. 11, 2007 (KR) 10-2007-0092152

(51) Int. Cl. G06F 17/00

(52) U.S. Cl. 235/375

(57) ABSTRACT

According to the present invention, an apparatus and method for proving a user with a content by using a machine-readable code is provided. In an aspect of the present invention, provided is a method for implementation on a terminal for providing a user with at least one content by using a machine-readable code, the method comprising the steps of: receiving a machine-readable code; extracting a code value of the received machine-readable code; transferring the extracted code value to a first external computational device; receiving from the first external computational device at least one of a plurality of content IDs associated with the extracted code value; transmitting the at least one content ID to a second external computational device; and receiving from the second external computational device at least one content corresponding to the at least one content ID.

### CROSS-REFERENCE TO RELATED APPLICATION

This application claims priority to and the benefit of Korean Patent Application No. 10-2007-0092152 filed in the Korean Intellectual Property Office on Sep. 11, 2007, the entire content of which is incorporated herein by reference.

### FIELD OF THE INVENTION

The present invention relates to an apparatus and method for providing a user with a content, and in particular, to an apparatus and method for enabling a user to retrieve or download a content via a communication network by reading a machine-readable code associated with the content with the user's terminal. More particularly, the present invention relates to an apparatus and method for enabling a user to retrieve or download a content from a web server by reading a machine-readable code associated with the content with the user's portable terminal. Accordingly, the present invention will now be described with a focus on the case where a user is provided with a content from a web server via the wireless Internet by means of a portable terminal, wherein the content is associated with a code value encoded in a bar code, which is a kind of exemplary machine-readable code.

### BACKGROUND OF THE INVENTION

Recent advances in wireless communication technologies and wide use of portable communication devices have increased the number of users of the wireless Internet, and this results in development of various internet contents and contents providing services, reflecting the needs of an increasing number of users.

In other words, use of wireless contents has become more common in an everyday life with a portable terminal (such as a mobile phone, a Personal Digital Assistant (PDA) and a Portable Multimedia Player (PMP)) being widely used. Those portable terminals are available for accessing the Internet through wireless communication. Accordingly, various wireless contents (such as a virtual character, a telephone ring tone, an e-mail, a news article and a moving image) have been widely used on a user's portable terminal.

However, when a user accessed wireless contents by using a portable terminal and wanted to be provided with specific information, the user had to connect to the wireless Internet and then enter an address and every single key word related to the desired information. This has been one reason that a user became reluctant to utilize wireless contents.

For instance, in case a user accessed the wireless Internet by using a portable terminal such as a mobile phone and was willing to purchase a soccer ticket in advance, the user had to carry out several key operations on the portable terminal, in order to find or input an address of a web site selling the soccer ticket and pay for the ticket after designating a seat on the web site. Such inconvenience due to the many key operations might extend a required connection time to the wireless Internet, and thus, put an increased financial burden on the user.

Accordingly, in order to address these disadvantages from the conventional technology and facilitate more convenient use of the wireless contents, there has been suggested an approach for accessing wireless contents by using a one-dimensional or two-dimensional bar code.

First, referring to Korean Patent Application No. 2001-38933 filed on Jun. 30, 2001 by the present applicant and registered as Korean Patent No. 414523 on Jan. 7, 2004, the entire content of which is incorporated herein by reference, an apparatus and method for obtaining information from a code extracted from a bar code pattern could be understood.

According to this patent, there are disclosed an apparatus and method for issuing a bar code pattern having a code therein from a code management server, inserting the issued bar code pattern onto various carrying media such as a newspaper, a broadcast screen and an advertisement, providing a user with the various media in which the issued bar code pattern is inserted, obtaining the bar code pattern by using a digital device (e.g., a scanner, a digital camera or a portable terminal equipped with a camera) for acquiring an image, extracting a code from the obtained bar code pattern, receiving from the code management server a locator (such as an URL) associated with the code, and accessing a web site with the locator. With the above apparatus and method, a user can obtain information conveniently.

Next, referring to Korean Patent Application No. 2002-81484 filed on Dec. 18, 2002 by the present applicant and laid open on Jun. 25, 2004 as Korean Patent Laid-open Publication No. 2004-54445, the entire content of which is incorporated herein by reference, there are provided a platform for using a bar code to provide a user with a content from an on-line or off-line company and a system and method for offering such a content by way of the platform.

According to this laid-open application, there is disclosed a system comprising a user's terminal connected with a network, an operation agency platform for receiving the code value from the user's terminal and providing the code value to a communication service provider's platform, and a communication service provider's platform for receiving the code value from the operation agency platform, offering a content corresponding to the code value and leaving a log on both the user and the related companies. Further, the system comprises a module for registering resources related to various contents on the communication service provider's platform and providing the user's terminal with the contents, and an off-line company's module for receiving from the operation agency company a bar code image associated with one of the contents and inserting the bar code image onto an off-line medium.

Moreover, referring to Korean Patent Application No. 2003-14598 filed on Mar. 8, 2003 by the present applicant and KTF Co., Ltd. and laid open on Sep. 16, 2004 as Korean Patent Laid-open Publication No. 2004-79625, the entire content of which is incorporated herein by reference, there is provided a method for providing a user's terminal with a content by using a bar code pattern.

The method in accordance with this laid-open application includes the steps of photographing a bar code pattern attached in relation to a content and carried on a printed document by using a user's terminal, decoding the photographed bar code pattern to extract a code value, extracting URL information corresponding to the code value, transmitting a message for requesting a content to a service provider's server on the URL, and transferring the content from the service provider's server to the user's terminal.

According to all of the above conventional arts, however, only one content has been obtainable from a bar code pattern because it shall one-to-one correspond to the code value extracted from the bar code pattern. In this case, a user may be deprived of a chance to experience various contents. Besides, in case a content is improper for a user (for example, in case a user is under age and a content is only for adults), such a content should not be accessed by the user. However, in case of employing one of the above conventional configurations, there has been a limit to control a user's access to a specific content.

### SUMMARY OF THE INVENTION

It is, therefore, an object of the present invention to resolve the problems of the conventional technologies.

It is another object of the present invention to provide an apparatus and method for providing a user with a content in various ways.

It is yet another object of the present invention to provide an apparatus and method for providing a user only with a content that is proper for the user, depending on the characteristics of the content.

In an aspect of the present invention, provided is a terminal for providing a user with at least one content by using a machine-readable code, the terminal comprising: means for receiving a machine-readable code; means for extracting a code value from the received machine-readable code; means for transferring the extracted code value to a first external computational device; means for receiving from the first external computational device at least one of a plurality of content IDs associated with the extracted code value; means for transmitting the at least one content ID to a second external computational device; and means for receiving from the second external computational device at least one content corresponding to the at least one content ID.

In another aspect of the present invention, provided is a computational device for providing a terminal with at least one content by using a machine-readable code, the computational device comprising: means for receiving a code value of a machine-readable code from a terminal; means for extracting at least one of a plurality of content ID stored in conjunction with the received code value; and means for transmitting the at least one content ID to the terminal.

In yet another aspect of the present invention, provided is a computational device for providing a terminal with at least one content by using a machine-readable code, the computational device comprising: means for receiving from a terminal at least one of a plurality of content IDs stored in conjunction with a code value of a machine-readable code; means for extracting at least one content stored corresponding to the at least one content ID; and means for transmitting the at least one content to the terminal.

In still yet another aspect of the present invention, provided is a method for implementation on a terminal for providing a user with at least one content by using a machine-readable code, the method comprising the steps of: receiving a machine-readable code; extracting a code value of the received machine-readable code; transferring the extracted code value to a first external computational device; receiving from the first external computational device at least one of a plurality of content IDs associated with the extracted code value; transmitting the at least one content ID to a second external computational device; and receiving from the second external computational device at least one content corresponding to the at least one content ID.

In still yet another aspect of the present invention, provided is a method for implementation on a computational device for providing a terminal with at least one content by using a machine-readable code, the method comprising the steps of: receiving a code value of a machine-readable code from a terminal; extracting at least one of a plurality of content IDs stored in conjunction with the received code value; and transmitting the at least one content ID to the terminal.

In still yet another aspect of the present invention, provided is a method for implementation on a computational device for providing a terminal with at least one content by using a machine-readable code, the method comprising the steps of: receiving from a terminal at least one of a plurality of content IDs stored in conjunction with a code value of a machine-readable code; extracting at least one content stored corresponding to the at least one content ID; and transmitting the at least one content to the terminal.

### BRIEF DESCRIPTION OF THE DRAWINGS

The above and other objects and features of the present invention will become apparent from the following description of preferred embodiments given in conjunction with the accompanying drawings, in which:

FIG. 1 shows an overall view of a system in accordance with the present invention for providing a content to a user by using a bar code pattern;

FIG. 2 provides a block diagram showing an internal structure of a user's portable terminal in accordance with an embodiment of the present invention;

FIG. 3 provides a block diagram showing an internal structure of a first server in accordance with an embodiment of the present invention;

FIG. 4 provides a block diagram showing an internal structure of a second server in accordance with an embodiment of the present invention;

FIG. 5 furnishes a flow chart showing a process in which a user's portable terminal is provided with a content according to a first embodiment of the present invention; and

FIG. 6 furnishes a flow chart showing a process in which a user's portable terminal is provided with a content according to a second embodiment of the present invention.

### DETAILED DESCRIPTION OF THE PREFERRED EMBODIMENTS

In the following detailed description, reference is made to the accompanying drawings that show, by way of illustration, specific embodiments in which the present invention may be practiced. These embodiments are described in sufficient detail to enable a person skilled in the art to practice the present invention. It is to be understood that the various embodiments of the present invention, although different, are not necessarily mutually exclusive. For example, a particular feature, structure, or characteristic described herein in connection with one embodiment of the present invention may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention will now be described in more detail, with reference to the accompanying drawings.

The Entire Configuration of a System

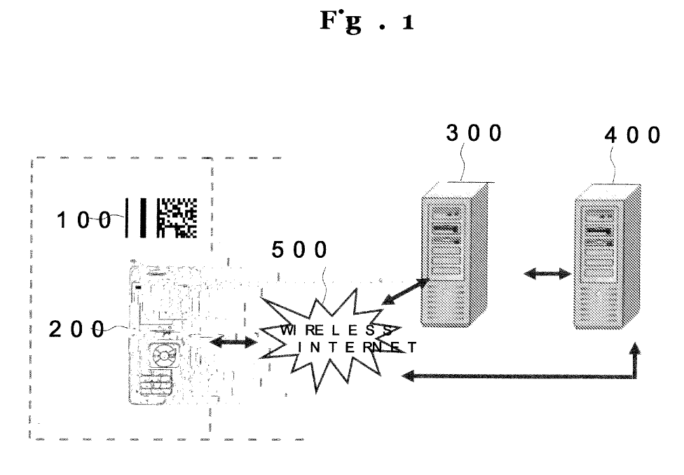

FIG. 1 shows an overall view of a system in accordance with the present invention for providing a content to a user by using a bar code pattern.

As shown in FIG. 1, the system for providing a content by using a bar code 100 includes the wireless Internet 500, a user's portable terminal 200, a first server 300 (hereinafter, also referred to as an implication server) for managing and providing content IDentification (ID) information usable for extracting a content, a database (not shown) belonging to the first server 300 for storing content ID information, a second server 400 (hereinafter, also referred to as a content server) for providing the user's portable terminal 200 with a content, and a database (not shown) belonging to the second server 400 for storing various contents that may be provided to the portable terminal 200.

A bar code 100 is an optically readable code consisting of data (i.e., code values comprised in a character, a number or a special character) in the form of one or a combination of black, white or colored symbols. In relation to the present invention, it is to be understood that all kinds of different codes, which are patterned to be readable by a computer and so as to expedite the process of data entry on a computer, are regarded as being equivalent to a bar code.

Referring to FIG. 1, it is noted that the entire system in accordance with the present invention may employ a two-dimensional bar code 100, but a bar code that can be used in the present invention needs not be limited to such a two-dimensional bar code.

Further, a bar code 100 available for the present invention may be either a one-dimensional bar code having lines with a different width or a two-dimensional bar code, which is a two-dimensional expansion of a one-dimensional bar code.

The one-dimensional bar code and the two-dimensional bar code may be used alternatively to each other. However, although the one-dimensional bar code can have relatively simple information such as numbers, alphabetical characters and combinations thereof, it may be more desirable to use the two-dimensional bar code having more information than the one-dimensional bar code. In particular, the two-dimensional bar code has much larger data inclusion capacity and is also advantageous to be printed and read than the one-dimensional bar code because the two-dimensional bar code is represented in a plane where data may be both horizontally and vertically encrypted.

Referring to Korean Patent Application No. 2002-66980 filed on Oct. 31, 2002 by the present applicant and registered as Korean Patent No. 414524 on Jan. 7, 2004, the entire content of which is incorporated herein by reference, there are provided a two-dimensional bar code that guarantees good decoding features and enables a step-by-step error correction and a method for producing and decoding the above two-dimensional bar code. Besides, there are various prior arts related to generating a two-dimensional bar code. Since such prior arts for generating and using a two-dimensional bar code may be readily found and reviewed, detailed explanations thereon are omitted.

Further, although a bar code 100 has been mentioned as an exemplary machine-readable code above, a variety of machine-readable codes (such as a Universal Product Code (UPC) and a European Article Number (EAN)) may be used to implement an embodiment of the present invention.

According to a preferred embodiment of the present invention, a Radio Frequency IDentification (RFID) code may be also used to implement an embodiment of the present invention as a machine-readable code.

RFID is a technology using electromagnetic or electrostatic coupling in a radio frequency band of the electromagnetic spectrum in order to read codes. In the industrial circles, the RFID is being more and more popularized, and expected to replace the bar code recognition technology in the future. The advantage of using the RFID technology lies in that there is no need to contact an object directly or scan an object in the visible band. An RFID system includes an antenna, a transceiver (generally integrated with a reader) and a transponder. The antenna uses a radio frequency wave in order to transmit a signal for activating the transponder. When activated, the transponder transmits data to the antenna. The data is generally handed over to a control logic performing various computational works (e.g., enabling a person to pass through a door or transacting an e-trade in association with databases). Accordingly, an RFID code may include a code value associated with a content to implement an embodiment of the present invention, instead of the bar code 100 that is recognizable by means of an optical instrument such as a camera.

Next, the entire system in accordance with the present invention includes a user's portable terminal 200 such as a mobile phone, a PDA, a PMP and the like, as described above. Also, the type of the portable terminal 200 needs not be limited to a specific one, as far as the portable terminal 200 can be used for reading a machine-readable code such as a bar code 100 and providing a user with a content related thereto, depending on the technical idea of the present invention. So to speak, the portable terminal 200 in accordance with the present invention may be one of a laptop computer, a digital camera, a camcorder, a bar code reader, an RFID reader and the like. Moreover, the terminal in accordance with the present invention needs not be limited only to a portable one. Thus, even a desktop computer may be used as a user terminal in accordance with the present invention.

Preferably, the portable terminal 200 might be required to have a camera (not shown) capable of recognizing an image of the bar code 100. Herein, a camera is referred to as an exemplary one of all kinds of devices capable of optically recognizing and obtaining a bar code image.

The portable terminal 200 may receive not the bar code image but a number written along with the bar code 100. In this case, the portable terminal 200 may further include a function of recognizing an image of a number. Otherwise, the portable terminal 200 may enable a user to input the number by pushing buttons on the portable terminal 200. In any case, the portable terminal 200 can receive information related to the bar code pattern.

In the meantime, according to a preferred embodiment of the present invention, the portable terminal 200 is required to not only recognize and decode the bar code image but also extract a code value included in the bar code 100. Accordingly, the portable terminal 200 may need to either include a program module related to decoding the bar code image or download such a program module from an external device.

Referring to Korean Patent Application No. 2000-10833 filed on Mar. 3, 2000 by H. K Lee and registered as Korean Patent No. 323759 on Jan. 25, 2002, the entire content of which is incorporated herein by reference, there is provided a method for extracting a specific code from a bar code pattern by using a mobile terminal equipped with a camera and displaying or providing information related to the specific code on the mobile terminal via a communication network. Although various approaches can be applied to decoding a bar code image, such approaches would be easily found and understood by a person skilled in the art, and therefore, detailed explanations on those are omitted in the present specification.

Therefore, according to a representative embodiment of the present invention, the portable terminal 200 may be equipped with a camera that can photograph an image of the bar code 100, and analyze the photographed bar code image by using a well-known bar code analysis program module, thereby extracting a code value from the bar code 100.

Meanwhile, the first server 300 shown in FIG. 1 can play a role in associating a code value encoded in the bar code 100 with at least one content included in the second server 400. In detail, the first server 300 may include, for example, a database (not shown), which may alternatively be connected with the first server 300, and the database of the first server 300 may preferably include content IDs, which are associated with code values from the bar codes.

In the database of the first server 300, one code value may preferably be associated with a plurality of content IDs. Thus, at least one of the plural content IDs associated with the code value can be transmitted to the portable terminal 200. Then, the portable terminal 200 can retrieve from the second server 400 at least one specific content corresponding to the at least one content ID. Obviously, the at least one content may alternatively be downloaded to the portable terminal 200, depending on the user's needs or the properties of the content. Moreover, although the present specification illustrates two aspects of using a content according to the present invention are retrieval and download, it is to be understood that forwarding a content or attaching metadata to a content can be regarded as another aspect of using a content according to the present invention.

Further, the second server 400 shown in FIG. 1 is a server for providing at least one content to the portable terminal 200 according to the present invention. The second server 400 receives a content request message including at least one content ID from the portable terminal 200, extracts at least one content corresponding to the at least one content ID and transmits the at least one content to the portable terminal 200.

According to a preferred embodiment of the present invention, the second server 400 may be a mirroring server for collecting a number of contents from web servers in advance or on a real-time basis and storing the collected contents. In this embodiment, the portable terminal 200 may access and use the contents in the mirroring server, which is located by an URL that may be already known to the portable terminal 200.

Portable Terminal

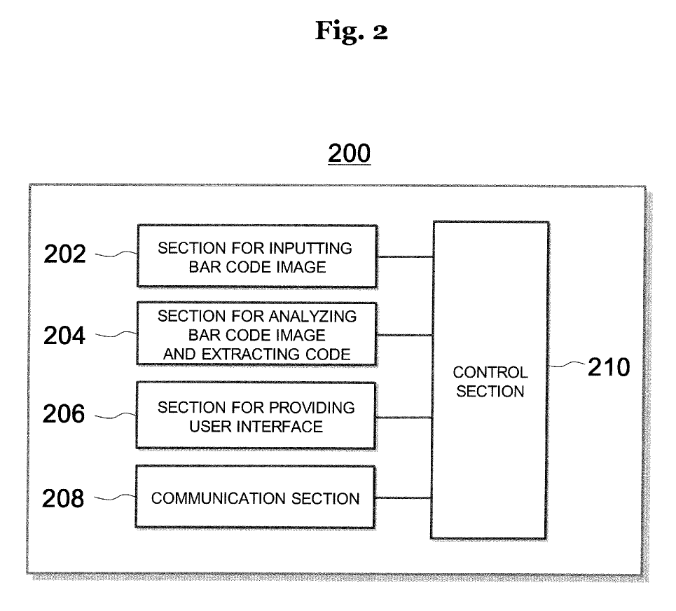

Referring to FIG. 2, the detailed configuration of the portable terminal 200 will be described as follows.

FIG. 2 provides a block diagram showing an internal structure of a user's portable terminal 200 in accordance with an embodiment of the present invention. It should be noted in FIG. 2 that some elements of the portable terminal 200 in accordance with an embodiment of the present invention are omitted because they can be found in a common mobile phone.

As described in FIG. 2, the portable terminal 200 includes a section 202 for inputting a bar code image, a section 204 for analyzing a bar code image and extracting a code value from a bar code image, a section 206 for providing a user interface, a communication section 208 and a control section 210. Herein, all or part of the elements corresponding to reference numerals 202 to 210 may be a program module included in the portable terminal 200. Such a program module may be one of a routine, a sub-routine, a program, an object, a component, a data structure and the like, which carries out a specific task or an operation related to a type of specific data, which will be described below according to the present invention, not in a limiting sense. Further, at least some of the above elements may be included in an external storage device connected with the portable terminal 200. Furthermore, the above elements may be included in the portable terminal 200 in the form of an operating system, an application program module or other kinds of program module, or stored in several storage devices that are physically separated.

The section 202 for inputting a bar code image inputs to the portable terminal 200 a bar code image obtained by a photographing means (such as a camera, a scanner and a digital camera) connected with or included in the portable terminal 200.

The section 204 for analyzing a bar code image and extracting a code value from a bar code image converts into digital image data analog image data, which have been obtained at the section 202 for inputting a bar code image. Then, the section 204 for analyzing a bar code image and extracting a code value from a bar code image decodes the digital image data and extracts a code value from the digital image data.

The section 206 for providing a user interface provides a user with a user interface for connecting the portable terminal 200 with the first server 300 and/or the second server 400 and enabling the user to operate on the portable terminal 200 after the connection has been established, thereby enabling the user to be conveniently provided with a content by using the portable terminal 200.

The communication section 208 transmits the extracted code value to the first server 300, receives from the first server 300 at least one content ID corresponding to the extracted code value, transmits to the second server 400 a content request message including the at least one received content ID, and receives at least one content corresponding to the at least one content ID. According to one embodiment of the present invention, the user's personal information (e.g., the user's personal identification information, the user's age, the user's favorite web site, the user's favorite content type and so on) or the information on the portable terminal 200 (e.g., the terminal's kind, the terminal's identification number, the price of the terminal and so on) may be transmitted to the second server 400 together with the content request message. In particular, the user's age may be utilized to prevent an adult-only content from being exposed to an under-age person. The user's personal information or the information on the portable terminal 200 may be utilized on its own or along with additional information on a content when the content is selected in the first server 300 or the second server 400.

The control section 210 is a computational section, which generates and processes a control signal for controlling each of the elements corresponding to reference numerals 202 to 208.

With regard to the feature of photographing a bar code image with a camera on the portable terminal 200 such as a mobile phone and analyzing the bar code image to extract information embedded in the bar code 100, Korean Patent Application No. 2000-85811 filed on Dec. 29, 2000 by the present applicant and registered as Korea Patent No. 404306 on Oct. 22, 2003, the entire content of which is incorporated herein by reference, may be referred to. Therefore, detailed descriptions on extracting a code value from a bar code image are omitted.

Although some elements of the present invention have been described with reference to several inventions suggested by the present applicant and/or other applicants, as mentioned above, such descriptions should not be utilized in order to limit the technical concept of the present invention. In other words, it is to be understood that such descriptions are made just to provide an exemplary one of the prior arts available for implementing an embodiment of the present invention.

First Server

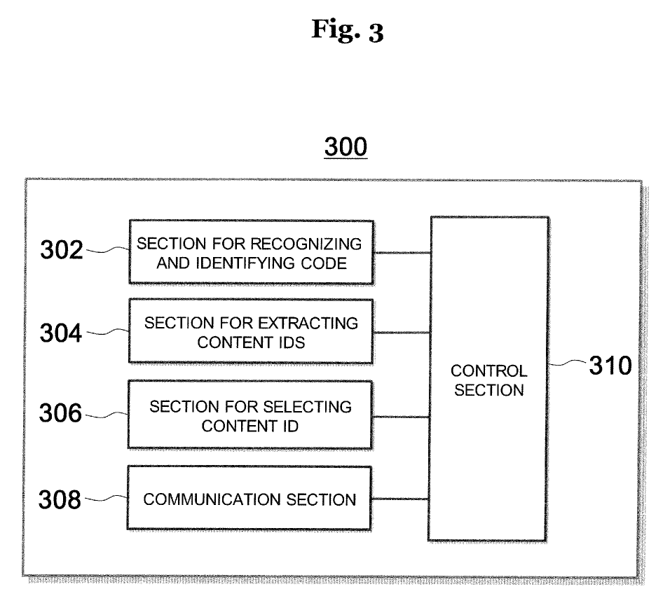

FIG. 3 provides a block diagram showing an internal structure of a first server 300 in accordance with an embodiment of the present invention.

As shown in FIG. 3, the first server 300 includes a section 302 for recognizing and identifying a code, a section 304 for extracting content IDs, a section 306 for selecting a content ID, a communication section 308 and a control section 310. In particular, the first server 300 receives a code value from the portable terminal 200, extracts a plurality of content IDs corresponding to the code value and transmits at least one of the plural content IDs to the portable terminal 200. Herein, all or part of the elements corresponding to reference numerals 302 to 310 may be a program module included in the first server 300. Such a program module may be one of a routine, a sub-routine, a program, an object, a component, a data structure and the like, which carries out a specific task or an operation related to a type of specific data, which will be described below according to the present invention, not in a limiting sense. Further, at least some of the above elements may be included in an external storage device connected with the first server 300. Furthermore, the above elements may be included in the first server 300 in the form of an operating system, an application program module or other kinds of program module, or stored in several storage devices that are physically separated.

As roughly described above, the first server 300 extracts from its database a plurality of content IDs corresponding to a code value from a bar code 100, wherein at least one content to be extracted from the second server 400 corresponds to one of the plural content IDs.

The section 302 for recognizing and identifying a code receives a code value from the portable terminal 200 and recognizes the code value. Then, the section 302 for recognizing and identifying a code may perform pre-processes for extracting a plurality of content IDs corresponding to the code value. Herein, the pre-processes may be one or more of cutting of the code, concatenation of the code, an error correction, a confirmation of a checksum and so on.

The section 304 for extracting content IDs extracts a plurality of content IDs corresponding to the pre-processed code. Since the code value received from the portable terminal 200 is stored in the database of the first server 300 in association with a plurality of content IDs, the section 304 for extracting content IDs is capable of extracting the plural content IDs corresponding to the code value from the database of the first server 300.

The section 306 for selecting a content ID selects at least one content ID among the extracted content IDs at random or on the basis of additional information. In case at least one content ID is selected at random, the respective content ID may be selected in an equal or unequal probability. Or, a content ID may be selected on the basis of other auxiliary information (such as a popularity of a content, a count of retrieving a content, a count of downloading a content and a content type) that can be obtained from the second server 400. Of course, the section 306 for selecting a content ID may be omitted. Besides, all content IDs corresponding to the code value obtained from the portable terminal 200 may also be extracted from the database of the first server 300 and transmitted to the portable terminal 200 unconditionally.

The communication section 308 receives a code value from the portable terminal 200, and transmits at least one content ID to the portable terminal 200. In other words, the communication section 308 enables data to be received/transmitted from/to the first server 300.

The control section 310 is a computational section for generating and processing a signal to control each of the elements corresponding to reference numerals 302 to 308.

Second Server

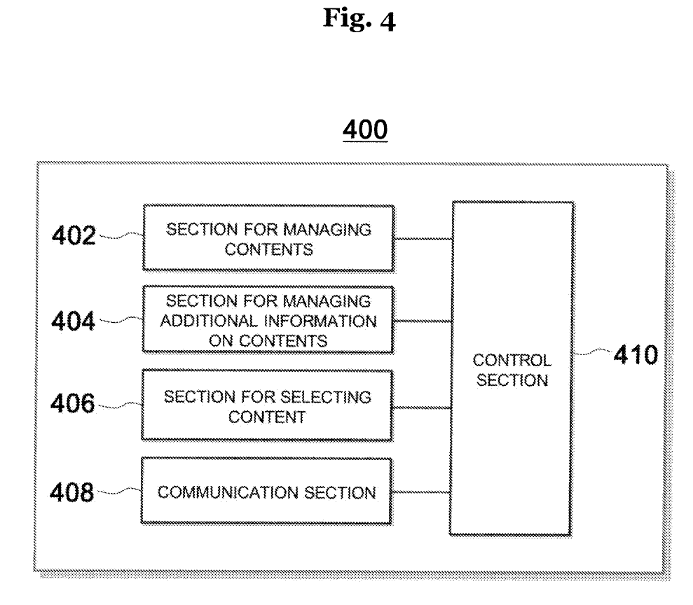

FIG. 4 provides a block diagram showing an internal structure of a second server 400 in accordance with an embodiment of the present invention.

As described in FIG. 4, the second server 400 includes a section 402 for managing contents, a section 404 for managing additional information on contents, a section 406 for selecting a content, a communication section 408 and a control section 410. As described above, the second server 400 receives a content request message including at least one content ID from the portable terminal 200, extracts at least one content corresponding to the at least one content ID, and provides the portable terminal 200 with the at least one extracted content. In the following, the function of each of the elements included in the second server 400 will be described in detail. Herein, all or part of the elements corresponding to reference numerals 402 to 410 may be a program module that is included in or in connection with the second server 400. The properties of such a program module would be similar to those of the program module in the first server 300.

First, the section 402 for managing contents stores and manages various contents, which the second server 400 provides to the portable terminal 200.

The section 404 for managing additional information on contents stores and manages additional information on contents such as a registration date of a content, information on limiting a user's right to use a content, a count of retrieving a content, a count of retrieving a content by reading a bar code according to the present invention, a count of downloading a content, and a count of downloading a content by reading a bar code according to the present invention. Herein, the additional information on contents in accordance with the present invention may be classified into intrinsic information or non-inherent information. As the latter kind of information, a count of retrieving a content or a count of downloading a content may be mentioned.

The section 406 for selecting a content selects at least one content corresponding to the at least one content ID received from the portable terminal 200 at random or on the basis of additional information. In case there are selected two or more contents, the section 406 for selecting a content may be capable of further selecting one or part of the selected contents at random or on the basis of other auxiliary information. Also, all or part of the selected contents may be provided in a sequence, which may be adjusted by a person skilled in the art. In case one or more contents are selected at random, each of the contents may be selected in an equal or unequal probability. Or, one or more contents may be selected based on other auxiliary information (such as a popularity of a content, a count of retrieving a content, a count of downloading a content and a content type) that can be obtained from the second server 400. Of course, if the number of the selected content is just one or all of the contents corresponding to the at least one content ID may be extracted and provided, no selection process may need to be performed. In any case, only the content corresponding to the at least one content ID received from the portable terminal 200 can be extracted from the database of the second server 400 and transmitted to the portable terminal 200.

The communication section 408 receives at least one content ID from the portable terminal 200, and transmits the at least one extracted content corresponding to the at least one received content ID from the second server 400 to the portable terminal 200. In other words, the communication section 408 enables data to be transmitted/received to/from the second server 400.

The control section 410 is a computational section for generating and processing a signal to control each of the elements corresponding to reference numerals 402 to 408.

Process on the Entire System

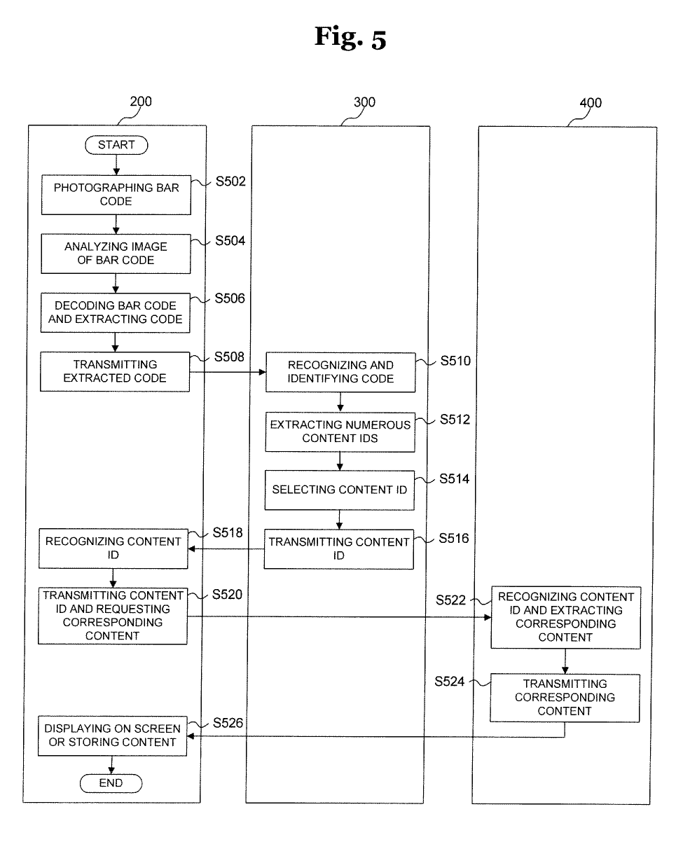

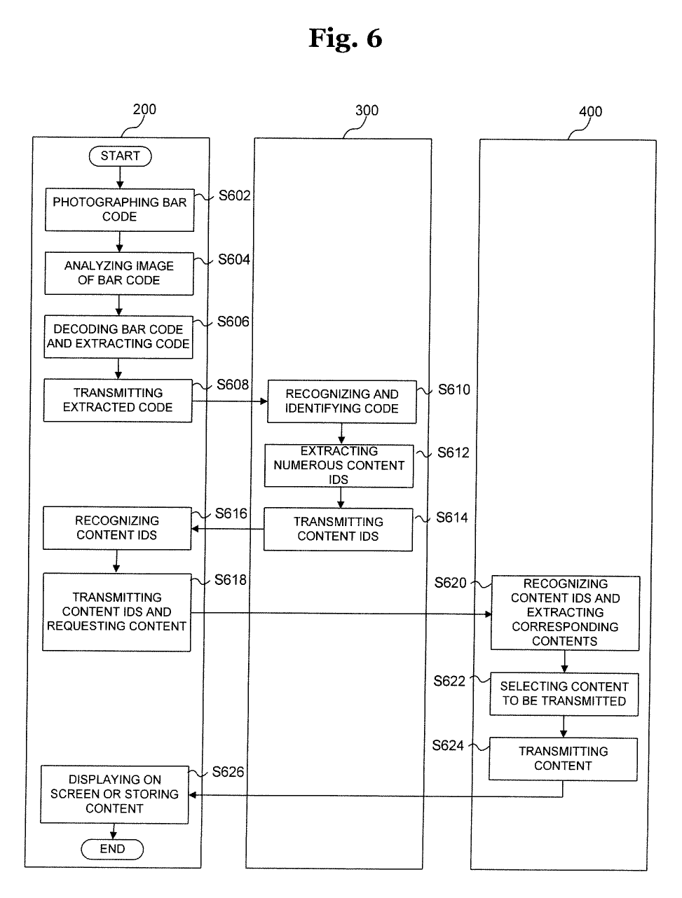

In the following, the processes on the entire system in accordance with preferred embodiments of the present invention will be described with reference to FIGS. 5 and 6.

FIG. 5 furnishes a flow chart showing a process in which a user's portable terminal 200 is provided with a content according to a first embodiment of the present invention.

First, a user photographs a bar code 100 patterned on an offline medium such as a printed document (e.g., a newspaper or a magazine) by using a photographing device such as a camera on the portable terminal 200 (S502).

Next, a section 204 for analyzing a bar code image and extracting a code value from a bar code image in the portable terminal 200 analyzes the photographed bar code image (S504), decodes the bar code image and extracts a code value from the bar code image (S506).

Subsequently, the portable terminal 200 transmits the extracted code value to the first server 300 (S508).

The section 302 for recognizing and identifying a code in the first server 300 recognizes and identifies the code value received from the portable terminal 200 (S510).

Then, the section 304 for extracting content IDs extracts a plurality of content IDs from the database of the first server 300 (S512).

And, among the extracted content IDs, one content ID is selected by the section 306 for selecting a content ID (S514). Then, the selected content ID is transmitted from the first server 300 to the portable terminal 200 (S516), and the portable terminal 200, which recognizes the received content ID (S518) and issues a request message including the content ID to the second server 400 (S520).

The second server 400 recognizes the content ID transmitted from the portable terminal 200, and extracts one content corresponding to the content ID (S522). The extracted content is transmitted to the portable terminal 200 (S524).

Finally, after the portable terminal 200 displays on a screen or stores the content (S526).

FIG. 6 furnishes a flow chart showing a process in which a user's portable terminal 200 is provided with a content according to a second embodiment of the present invention.

According to the second embodiment of the present invention, numerous content IDs corresponding to a code value are extracted from the first server 300 and a content request message including the extracted numerous content IDs is then transmitted to the second server 400. Alternatively, the numerous content IDs can be separately included in numerous content request messages that are to be issued in order.

Steps S602 to S608 of the second embodiment are the same as steps S502 to S508. That is, a code value extracted from the bar code image is transmitted from the portable terminal 200 to the first server 300 through the steps S602 to S608.

Then, the section 302 for recognizing and identifying a code in the first server 300 recognizes and identifies the code value (S610).

Thereafter, the section 304 for extracting content IDs extracts a plurality of content IDs corresponding to the code value transmitted from the portable terminal 200 (S612).

Differently from in the first embodiment described in conjunction with FIG. 5, all the extracted content IDs are transmitted to the portable terminal 200 (S614).

Then, the portable terminal 200 recognizes the received content IDs and transmits them to the second server 400, thereby requesting a content (S616 and S618).

The second server 400 recognizes the plural content IDs transmitted from the portable terminal 200, and extracts numerous contents, each of which corresponds to each of the content IDs (S620). Then, the second server 400 selects one content among the extracted contents to be transmitted to the portable terminal 200 (S622).

The content selected in step S622 is transmitted from the second server 400 to the portable terminal 200 (S624). Finally, the portable terminal 200 receives the transmitted content, and displays on a screen or downloads it for use by the user (S626).

Implementation Example of the Present Invention

In the following, an implementation example for the present invention will be described to help understand how to implement an embodiment of the present invention.

For instance, it may be assumed that a user wants to change a ring tone of his or her mobile phone to a melody of the latest popular song when the user gets to see an advertisement for a ring tone, which is shown in an off-line printed medium such as a newspaper.

To this end, the user takes a picture of a bar code located near the advertisement by using a camera on his or her mobile phone. In the bar code, a code value corresponding to a plurality of melodies of latest popular songs is embedded.

Then, the mobile phone decodes the bar code image to obtain a code value corresponding to a plurality of content IDs, and then transmits it to an implication server.

Thereafter, the numerous content IDs, which are associated with ring tone contents, are extracted from the implication server.

According to a first embodiment, a randomly selected content ID may be extracted from the implication server, and with such content ID, the mobile phone may obtain an unexpected ring tone content from a content server.

According to a second embodiment, a plurality of content IDs may be extracted from the implication server, and with such content IDs, the mobile phone may request a ring tone content to a content server. Then, the content server randomly selects a ring tone content among ones corresponding to the plural content IDS. The selected ring tone content may also be an unexpected one to the user.

While the present invention has been shown and described with respect to the preferred embodiments, it will be understood by a person skilled in the art that various changes and modifications may be made without departing from the spirit and scope of the present invention as defined in the following claims.

What is claimed is:

1. A terminal for providing a user with at least one content by using a machine-readable code, the terminal comprising:
means for receiving a machine-readable code;
means for extracting a code value from the received machine-readable code;
means for transferring the extracted code value to a first external computational device;
means for receiving from the first external computational device at least one of a plurality of content IDs associated with the extracted code value;
means for transmitting the at least one content ID to a second external computational device; and
means for receiving from the second external computational device at least one content corresponding to the at least one content ID.

2. The terminal of claim 1, wherein the transferring means further transfers at least one selected from personal information on a user and information on the terminal.

3. The terminal of claim 1, wherein the transmitting means further transmits at least one selected from personal information on a user and information on the terminal.

4. The terminal of claim 3, wherein the personal information on a user includes at least one selected from the user's personal identification information, the user's age, the user's favorite web site and the user's favorite content type.

5. The terminal of claim 3, wherein the information on the terminal includes at least one selected from the terminal's kind, the terminal's identification number and the price of the terminal.

6. A computational device for providing a terminal with at least one content by using a machine-readable code, the computational device comprising:
means for receiving a code value of a machine-readable code from a terminal;
means for extracting at least one of a plurality of content ID stored in conjunction with the received code value; and
means for transmitting the at least one content ID to the terminal.

7. The computational device of claim 6 further comprising means for selecting a part of the at least one content ID at random or based on auxiliary information.

8. The computational device of claim 7, wherein the auxiliary information includes at least one selected from a popularity of a content, a count of retrieving a content, a count of downloading a content and a content type.

9. A computational device for providing a terminal with at least one content by using a machine-readable code, the computational device comprising:
means for receiving from a terminal at least one of a plurality of content IDs stored in conjunction with a code value of a machine-readable code;
means for extracting at least one content stored corresponding to the at least one content ID; and
means for transmitting the at least one content to the terminal.

10. The computational device of claim 9 further comprising means for managing additional information on a content.

11. The computational device of claim 10, wherein the additional information on a content includes at least one selected from a registration date of a content, information on limiting a user's right to use a content, a count of retrieving a content and a count of downloading a content.

12. The computational device of claim 9 further comprising means for selecting a part of the at least one content at random or based on auxiliary information.

13. The computational device of claim 12, wherein the auxiliary information includes at least one selected from a popularity of a content, a count of retrieving a content, a count of downloading a content and a content type.

14. A method for implementation on a terminal for providing a user with at least one content by using a machine-readable code, the method comprising the steps of:
receiving a machine-readable code;
extracting a code value of the received machine-readable code;
transferring the extracted code value to a first external computational device;
receiving from the first external computational device at least one of a plurality of content IDs associated with the extracted code value;
transmitting the at least one content ID to a second external computational device; and
receiving from the second external computational device at least one content corresponding to the at least one content ID.

15. The method of claim 14 further comprising the step of transmitting at least one selected from personal information on a user and information on the terminal.

16. The method of claim 15, wherein the personal information on a user includes at least one selected from the user's personal identification information, the user's age, the user's favorite web site and the user's favorite content type.

17. The method of claim 15, wherein the information on the terminal includes at least one selected from the terminal's kind, the terminal's identification number and the price of the terminal.

18. A method for implementation on a computational device for providing a terminal with at least one content by using a machine-readable code, the method comprising the steps of:
receiving a code value of a machine-readable code from a terminal;
extracting at least one of a plurality of content IDs stored in conjunction with the received code value; and
transmitting the at least one content ID to the terminal.

19. The method of claim 18 further comprising the step of selecting a part of the at least one content ID at random or based on auxiliary information.

20. The method of claim 19, wherein the auxiliary information includes at least one selected from a popularity of a content, a count of retrieving a content, a count of downloading a content and a content type.

21. A method for implementation on a computational device for providing a terminal with at least one content by using a machine-readable code, the method comprising the steps of:
receiving from a terminal at least one of a plurality of content IDs stored in conjunction with a code value of a machine-readable code;
extracting at least one content stored corresponding to the at least one content ID; and
transmitting the at least one content to the terminal.

22. The method of claim 21 further comprising the step of selecting a part of the at least one content at random or based on auxiliary information.

23. The method of claim 23, wherein the auxiliary information includes at least one selected from a popularity of a content, a count of retrieving a content, a count of downloading a content and a content type.
